(19) United States
(12) Patent Application Publication
(10) Pub. No.: US 2025/0278017 A1
(43) Pub. Date: Sep. 4, 2025

(54) METASURFACE-BASED ANTI-COUNTERFEITING DEVICE

(71) Applicant: Authentix, Inc., Addison, TX (US)

(72) Inventors: Graham BEALES, Boxborough, MA (US); Milad KHOSHNEGAR SHAHRESTANI, Boxborough, MA (US)

(21) Appl. No.: 18/858,059

(22) PCT Filed: Mar. 31, 2023
(86) PCT No.: PCT/EP2023/058530

§ 371 Date: Oct. 18, 2024

Related U.S. Application Data
(60) Provisional application No. 63/332,665, filed on Apr. 19, 2022.

(51) Int. Cl. G03B 25/00; B42D 25/30; B42D 25/324

(52) U.S. Cl. CPC G03B 25/00; B42D 25/30; B42D 25/324

(57) ABSTRACT

Displays includes a two-dimensional array of display pixels and methods for making such displays are disclosed.

### CROSS-REFERENCE TO RELATED APPLICATIONS

This application claims the benefit of priority to U.S. Application No. 63/332,665, filed on Apr. 19, 2022, the contents of which are hereby incorporated by reference.

### FIELD OF THE INVENTION

The present invention is in the field of optical displays, including optical authentication security displays. More particularly, this disclosure relates to multicolor optically variable displays enabled by reflective metasurface color filters on micro-patterned flexible substrates.

### BACKGROUND

Reflective optical variable devices (OVD) are used as anti-counterfeiting features for visual authentication purposes. These devices display at least one image, and more favorably a series of images, to the user depending on the user's viewing angle and the incident angle of the light source. The available anti-counterfeiting features can be categorized into 1) colorshift films, 2) surface relief holograms, and 3) and microstructure enabled OVDs.

The visual effect in colorshift films originates from optical interference in a thin film, or a stack of them, and includes a color transition as the observer navigates different viewing angles. Surface relief holograms are diffraction-based and a plurality of structurally different holograms can be put together in a pixel-to-pixel format.

However, diffraction based OVDs generally can have a limited view zone and can include rainbow effects. Microstructure-enabled diffraction based OVDs incorporate micro-lens or micromirrors to render a single image or multiple images in response to observer's interaction with the feature. Such OVDs may incorporate a plurality of micro-lenses or micro-mirrors for steering the optical beams reflected from a set of static images toward different viewing angles. The image resolution in such devices is limited by the printing resolution and may not be flexibly controlled to contain adequately large content into the limited physical area of a passive OVD. Another constraint here is how the image layer and the beam steering layer of the device interact with each other. The resolution-limited image cannot be rendered into adequate viewing angle manifolds to display a fluid animation.

Thus, what is needed are improved reflective OVDs.

### SUMMARY OF THE INVENTION

It has been discovered that metasurface patterns of nanostructures on displays with microstructured pixels can provide animations that can combine motion, depth, and parallax effects when viewed by a user. This discovery has been exploited to develop the present disclosure, which, in part, is directed to an anti-counterfeit display affixed to a substrate, such as a paper or polymer banknote. The display is composed of an array of display pixels, which reflect a portion of the spectrum of incident light into a corresponding viewing angle. Each display pixel includes an array of frame pixels. The frame pixels can be (at the microscale) substantially planar facets on the surface of the display pixels. Each frame pixel includes a metasurface pattern (e.g., structure at nanoscale) which determines the portion of the reflected spectrum (e.g., operating as a color filter).

The viewing angle of corresponding frame pixels sharing a coordinate (location) on each of the display pixels reflect at the same viewing angle. In some example, frame pixels at a given coordinate encode a frame of the animation across the display pixels. As a viewer observes the display over a range of viewing angles, the display projects image information such that a sequence of animation frames is presented to the viewer, for example to give the appearance of motion. In some further examples, for an additional range of viewing angles, the animation undergoes both motion and parallax effects, appearing to change in both space and time.

A summary of various aspects of the disclosure follows.

In one aspect, the present disclosure is directed to a display including a two-dimensional array of display pixels, the display comprises a substrate extending in a plane. and a polymer layer supported by the substrate, the polymer layer having a surface patterned to correspond to the two-dimensional array of display pixels. A shape of the surface within each display pixel varies with respect to the plane so that different areas of each display pixel reflect light incident on the display from a common direction into different viewing angles, each of the different areas corresponding to a respective frame pixel. The surface at each of the different areas includes a respective metasurface pattern. The display further comprises a layer of a first material on the surface of the polymer layer, the first material being different from a material composing the polymer layer. The metasurface patterns and the layer of the first material are configured so that the reflected light is spectrally filtered by each frame pixel. The metasurface patterns for different frame pixels of at least some of the display pixels vary so each of the at least some of the display pixels reflect differently colored light into the different viewing angles.

In some examples, the metasurface patterns for the frame pixels of each display pixel varies so that the display reflects incident light to present different images into at least some of the different viewing angles.

In some examples, the metasurface patterns for the frame pixels of each display pixel varies so that the different images correspond to different spatial views of an object.

In some examples, the metasurface patterns for the frame pixels of each display pixel varies so that the different images correspond to different frames in an animation of an object.

In some examples, the metasurface patterns of each display pixel varies in a first manner for the frame pixels so that the different images correspond to different frames in an animation of an object for different viewing directions in a first plane, and the metasurface patterns of each display pixel can vary in a second manner for the frame pixels so that the different images correspond to different spatial views of the object for different viewing directions. For example, the different spatial views may correspond to different directions not in the first plane, such as different views in a second plane, normal to the first plane.

In some examples, the surface of the polymer layer of each display pixel is dome-shaped.

In some examples, the first material includes a metal.

In some examples, the first material has a refractive index higher than a refractive index of the polymer layer.

In some examples, each display pixel includes an array of the frame pixels, each frame pixel in the array corresponding to a respective one of the different viewing angles.

In some examples, the metasurface patterns and layer of the first material are arranged so that each frame pixel spectrally filters incident light by plasmonic resonance.

In some examples, the display includes an adhesive layer between the substrate and the polymer layer.

In some examples, the display includes a protective layer, the polymer layer being arranged between the substrate and the protective layer.

In some examples, the layer of the first material substantially conforms to the metasurface pattern of each of the different areas.

In a second aspect, the present disclosure is directed to a method of manufacturing a display including a two-dimensional array of display pixels. The method comprises patterning a surface of a polymer layer to correspond to the two-dimensional array of display pixels, a shape of the surface within each display pixel varying with respect to a plane so that different areas of each display pixel reflect light incident on the display from a common direction into different viewing angles. Each of the different areas corresponds to a respective frame pixel, the surface at each of the different areas comprising a respective metasurface pattern. The method further comprises depositing a layer of a first material on the polymer layer, the first material being different from a material composing the polymer layer. The metasurface patterns and the layer of the first material are configured so that the reflected light is spectrally filtered by each frame pixel. The metasurface patterns for different frame pixels of at least some of the display pixels vary so that each of the at least some of the display pixels reflect differently colored light into the different viewing angles.

In some examples, the display is produced using nanoimprint lithography, or electron beam lithography.

In some examples, the polymer layer is patterned by embossing the surface of the polymer layer with a mold.

In some examples, the method includes laminating the polymer layer to a substrate.

In some examples, the method includes disposing a protective layer on a surface of the polymer layer opposite the patterned surface.

In some examples, the first material includes a metal and the material is deposited using sputtering methods.

In some examples, the first material includes a dielectric material and the material is deposited using thermal evaporation methods.

In some examples, depositing the first material includes depositing the layer of the first material to at least partially conform to the two-dimensional array of display pixels and to the corresponding frame pixels.

In some examples, the layer of the first material conforms to the metasurface pattern of each of the different areas.

In a third aspect, the present disclosure is directed to an optically variable device, including an array of microstructures, each microstructure including a plurality of metasurface patterns, the metasurface patterns constructed to reflect and spectrally filter incident light to present different images of an object into different viewing angles, the different images including a sequence of frames from an animation of the object and including different spatial views of the object for a given frame in the sequence.

In some examples, the different viewing angles corresponds to a dimension of the array of microstructures.

In some examples, when reflected incident light is viewed across a first range of viewing angles, different frames of the animation are presented to a viewer and when incident light is viewed across a second range of viewing angles, different from the first range of viewing angles, different spatial views of the frames of the animation are presented to the viewer.

In some examples, the metasurface patterns are configured to reflect and spectrally filter incident light to present respective frames of a sequence of frames from an animation of the object for different viewing angles lying in a first plane relative to the array of microstructures and to present different respective spatial views of the object for different viewing angles outside the first plane. In some examples, the metasurface patterns are configured to reflect and spectrally filter incident light to present respective different spatial views of the object for a given frame of the sequence of frames for different viewing angles lying in a second plane relative to the array of microstructures, the second plane being perpendicular the first plane.

Other features and advantages will be apparent from the description of examples below, the figures, and the claims.

### BRIEF DESCRIPTION OF THE DRAWINGS

The foregoing and other objects of the present disclosure, the various features thereof, as well as the disclosure itself may be more fully understood from the following description, when read together with the accompanying drawings in which:

FIG. 1 is a diagrammatic representation of a cross-sectional view of an exemplary flexible thin film stack embodiment used for metasurface-based overt authentication features, and showing two viewers;

FIG. 2 is a diagrammatic representation of an exemplary display device where its physical area is divided into equally-sized pixels Pᵢ;

FIG. 3 is a diagrammatic representation of a cross-sectional view of an exemplary display pixel having a hemisphere-like structure;

FIG. 4A is a diagrammatic representation of the projections for making an animated image appear on the surface of the sample;

FIG. 4B is a diagrammatic representation of the projected viewing direction of frame pixel C72 of FIG. 4A onto the plane of the animation arc;

FIG. 4C is a diagrammatic representation of the projected viewing direction of frame pixel C77 of FIG. 4A onto the plane of the animation arc;

FIG. 4D is a diagrammatic representation of the projected viewing direction of frame pixel C22 of FIG. 4A onto the plane of the animation arc;

FIG. 5 is a diagrammatic representation of an exemplary device display surface, highlighting four sets of frame pixels and the images shown by each of those sets of frame pixels;

FIG. 6A is a schematic representation of the projection of a polygon from the scene onto tan exemplary device's surface, for set of frame pixels' viewing angle;

FIG. 6B is a graphic representation of a texture map determining the colors of the polygon from the scene (FIG. 6A);

FIG. 7 is a schematic representation of the projection of a polygon from the scene onto an exemplary device's surface, for set of frame pixels' viewing.

FIG. 8 is a graphic representation of a scanning electron microscopy (SEM) image of nickel shim for a constructed plasmonic animation sample;

FIG. 9A is a graphic representation of a photographic image of a plasmonic animation sample from a first viewing angle; and

FIG. 9B is a graphic representation of a photographic image of the plasmonic animation sample from a second viewing angle.

### DETAILED DESCRIPTION

The disclosures of these patents, patent applications, and publications in their entireties are hereby incorporated by reference into this application in order to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used herein, the term “about” will be understood by persons of ordinary skill in the art and will vary to some extent on the context in which it is used. As used herein when referring to a measurable value such as an amount, a temporal duration, and the like, the term “about” is meant to encompass, in addition to the exact value specified, variations of ±20% or ±10%, including ±5%, ±1%, and ±0.1% from the specified value, as such variations are appropriate to perform the disclosed methods.

In the following description, in the context of electromagnetic radiation, the terms “light”, “ray”, “beam”, and “direction” may be used interchangeably and in association with each other to indicate the direction of propagation of the electromagnetic radiation along rectilinear trajectories.

For the purposes of explaining the invention well-known features of optical technology known to those skilled in the art of optically variable authentication security displays have been omitted or simplified in order not to obscure the basic principles of the invention. Parts of the following description will be presented using terminology commonly employed by those skilled in the art of optical design. Parts of the disclosure refer to metasurfaces and metasurface patterns. These terms can refer herein to a lattice (or pattern) of subwavelength structures which can reflect, transmit, absorb and scatter light. All in-plane dimensions parallel to the metasurface or pattern can be subwavelength and below the diffraction limit for the light for which the metasurface or metasurface pattern is designed, to avoid diffraction of the light. The pattern may be made by coating a thin film of metal or dielectric material on a material, for example a resin, embossed with the lattice or pattern of the structures. Subwavelength structures can be understood herein to be structures having in-plane dimensions parallel to the metasurface or metasurface pattern smaller than the wavelengths of light for which the metasurface is designed (the operative wavelengths of a device including the metasurface or metasurface pattern). Subwavelength structures can be nanostructures, having in-plane dimensions parallel to the metasurface or metasurface pattern at nanometer, sub-micrometer scale. In this disclosure, parts of the disclosure refer to “animation”, which can be understood in its common meaning as a sequence of image frames showing an object or scene that, when displayed in rapid succession, create an illusion of movement or other physical change of the image or scene. It should also be noted that in the following description of the invention repeated usage of the phrase “in one embodiment” does not necessarily refer to the same embodiment.

The present disclosure relates to multicolor optically variable displays enabled by reflective metasurface color filters on micro-patterned flexible substrates. The disclosure also relates to the production of optically variable authentication security displays enabled by high refractive index reflective metasurface color filters. In addition, the disclosure provides a method of nanoimprinting of a metastructure pattern onto micro-patterned thermoplastic polymer or photopolymer resin and coating the imprinted resin with high refractive index optical thin film.

The display devices are passive and utilize metasurface nanostructures overlaid onto microstructures (also referred to as “display pixels”) capable of displaying several frames of a movie-like animation. The nanostructures on the display pixels are spatially organized into corresponding areas also referred to as “frame pixels”. The frame pixels in a given location on the display pixels correspond to a frame of the animation. The location of the frame pixels of a frame on the display pixels correspond to a reflection direction of incident light from a common direction. Therefore, the display “plays” through the frames of the animation as the display is, for example, tilted relative to a viewer's viewpoint. In some examples, the movie-like animation plays through a sequence of many individual frames. The number of frames in the animation generally depends on the number of frame pixels manufactured into each display pixel in an array of display pixels, and the optical interaction of incident light with the nanostructures of the frame pixels. For example, the number of frames in an animation can correspond to (e.g., equal) the number of frame pixels in a row or column of the array of frame pixels in a display pixel. In some examples, the frame pixels in a given location of the display pixels correspond to a specific one of two or more spatial views, which may give a perception of depth due to different spatial views corresponding to different parallax axes. Frame pixels in a given location of the display pixels may correspond to a combination of a given spatial view of a given frame of the animation.

The maximum number of frames displayed by the display devices including nanostructures is limited by the display pixel size divided by the minimum periodicity of nanostructures. For example a display having a pixel size of 72 μm and a nanostructure periodicity of 120 nm can display up to 600 frames to a viewer for one parallax axis or spatial view of the object. If the display includes multiple parallax axes (spatial views), the total number of displayed frames will be display pixel size divided by the minimum periodicity of nanostructures multiplied by the number of parallax axes, e.g., 600*number of parallax axes in the above example. In some implementations, the minimum number of frames is two, e.g., in a display device having a switch effect.

The pattern of nanostructures forming the metasurface on each of the frame pixels (the metasurface pattern) can be subwavelength patterns indicating that a dimension of each nanostructure is less than the wavelength(s) of the incident light the nanostructure is intended to modify, e.g., the operating wavelength(s). In some cases, the nanostructures forming the metasurface pattern can be larger than the operating wavelength. An example is the phase gradient metasurface structures which add beam steering capabilities to the device in addition to that already provided by the display pixel facets, e.g., frame pixels, see for reference Sun et al., titled “High-Efficiency Broadband Anomalous Reflection By Gradient Meta-Surfaces,” Nano Lett. 2012, 12, 12, 6223-6229, which is incorporated herein by reference.

A pixel-to-pixel platform of display pixels can enable and combine both time-dependent animation and parallax-induced depth in a single device. Metasurface-based frame pixels can facilitate high resolution construction of sequential frames creating the effect of time-dependent animation in a limited physical space, while multi-pixel (e.g., multi-faceted) display pixels hosting metasurfaces on each frame pixel can allow for rendering optical beams into populous viewing angle directions and realization of a fluid animation through a perceived time dimension.

The surface of the device is designed by modifying existing two-dimensional rendering algorithms to render three-dimensional light field displays using the optical-steering features of display pixels and the spectral-filtering features of metasurface-based pixels on each display pixel. Further, the animation is added to the rendering algorithm through the replacement of time information in a typical animation with a spatial equivalent, an animation axis, which may enable presenting both animation and parallax effects using the same metasurface-based pixels.

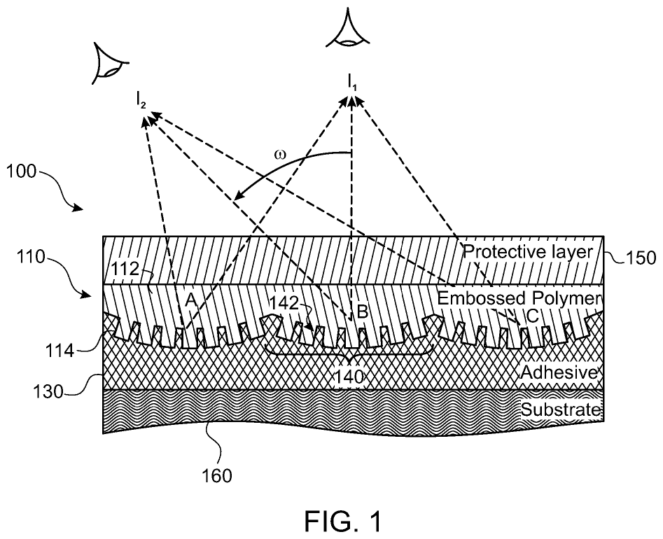

In certain examples, an authentication feature according to the disclosure includes a flexible thin film stack used for metasurface-based overt authentication. A cross-section of an example display device 100 is shown in FIG. 1. Display device 100 includes a protective layer 150, a film stack 110 including a UV/thermally embossed polymer layer 112 and a thin film layer 114 (e.g., a metallic or dielectric layer), an adhesive layer 130, and a substrate layer 160.

FIG. 1 illustrates the cross section of the device 100, with two viewers, I₁ and I₂. Viewer I₁ is observing the display pixel 140 of device 100 normal to the plane of the film stack 110, e.g., from the front, while viewer sees display pixel 140 at an angle from normal, ω. The viewers may be the same viewer observing the display pixel at different angles, for example, by tilting the display. FIG. 1 shows light paths indicated by dashed arrows originating from three display pixels, including display pixel 140, along the polymer layer 112. As will be described in more detail below, each display pixel includes an array of frame pixels configured to reflect light incident on the display 100 from a common direction into different directions so that a view at one location with respect to the display will see reflected light from only one frame pixel on each display pixel. By appropriate selection of metasurface patterns for each pixel frame to filter specific wavelength bands, each display pixel can appear with different colors and/or intensities at different viewing directions.

Thus, because of the viewing direction, viewer I₁ sees a first image generated by the reflection from different frame pixels 142 of the same display pixel 140 and the corresponding pixel metasurface color filters, while viewer I₂ sees a second image, based on the different reflection angle, from different frame pixels and hence a different set of metasurface color filters. Based on this principle, information can be encoded into the metasurface of each frame pixel so that the display device 100 displays animation (e.g., along one direction) and parallax effects where motion is induced only by depth. In parallax effects, a displayed object appears static and the viewer can move around the displayed object, observing different perspectives of the object, or objects, at different viewing angles which conveys a sense of depth.

The device 100 displays information to the viewer over a range of angles, e.g., the viewing angle range, typically measured from the device normal. For example, device 100 can display the visual information across a view angle range along one axis (e.g., x-, or y-axis) of about +/−60° from normal. Generally, different frames are visible within a small portion of the viewing angle range, each frame subtending a range viewing angle. The angular resolution of a single frame in one or both directions can be about 3° or more (e.g., about 5° or more, about 8° or more, about 10° or more, such as about 15° or less). In some examples, an animation with 16 frames has an angular resolution of about 5 degrees per frame. Generally, the shape and dimensions of the display pixel 140 determine the viewing angle and, in general, larger viewing angle ranges can include higher animation information (e.g., frame counts).

The number of animation frames displayed by the overlaid nanostructures 140 generally depends on the display pixel 140 size and the periodicity of frame pixels 142. For example, a display pixel having a width of 72 μm with a 120 nm nanostructure period means that about 600 nanostructures can be arranged across the display pixel. A viewing angle of +/−60° with a size/period ratio of 600 defines an angular resolution of about 0.2° (e.g., 120° total viewing angle/600=0.2°).

In an example, the device 100 is 6.4 cm×1.65 cm and includes an array of 1000×258 display pixels. Each display pixel is 64 μm wide and includes of an array of 16×16 frame pixels where each frame pixel is a 4 μm×4 μm square.

The protective layer 150 is arranged on a surface of the display device 100 exposed to the environment and opposing the substrate. In this arrangement, the protective layer 150 prevents mechanical and chemical damage to the film layers, such as thin film stack 110, between the protective layer 150 and the substrate layer 160. The protective layer 150 is manufactured from a durable and chemically non-reactive material that is thin and flexible. Useful shield materials include, but are not limited to, lacquer or varnish which are either water-based, UV-curable, or thermal curable. In some implementations, the layer is made of UV curable resin. In some implementations, the layer thickness is in a range from about 2 microns to about 4 microns (e.g., from about 2.4 μm to about 3.6 μm, from about 2.4 μm to about 3.2 μm, from about 2.8 μm to about 3.6 μm, or from about 3 μm to about 4 μm). The thickness can depend on the manufacturing process or the layer material

The polymer layer 112 is patterned with the display pixels 140 including the metasurface frame pixels 142, which filter incident light over one or more visual parameter, such as color. The display pixels 140 are formed on the polymer layer 112, using method capable of patterning materials at the resolution needed, e.g., thermal embossing methods, nanoimprint lithography (NIL), and/or electron beam lithography (EBL). In some examples, the polymer layer 112 is an embossed layer embedding the pattern of shaped display pixels 140 including an array of frame pixels 142. Each frame pixels 142 on each display pixels 140 includes one or groups of nanostructures forming a metasurface. The polymer layer 112 is functionalized by depositing a thin film of metallic or high refractive index (HRI) dielectric layer forming film layer 114.

In some implementations, the layer 114 is substantially conformal (e.g., a layer of substantially constant thickness that covers the sidewalls, top surfaces, and troughs of the imprinted nanostructures 144) and, for example, deposited using sputtering methods. In another implementation, the layer 114 is conformally printed onto the embossed resin. In alternative implementations, the layer 114 is non-conformal (e.g., only partially covering sidewalls or covering over the top surface and the top of the trenches), and, for example, deposited using e-beam or thermal evaporation methods.

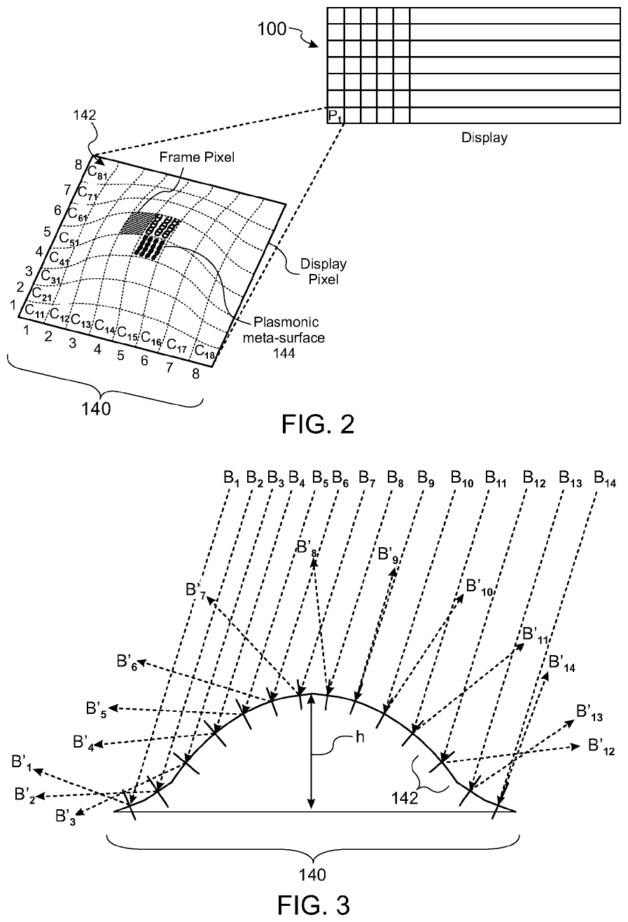

The thickness of the layer 114 can influence optical properties such as the modal dispersion properties of the optical modes, how the spectrum is filtered, and how the colors are produced, which in turn determines the color content of the rendered image. In some examples, metasurface structures, such as beam steering phase gradient metasurface structures, are utilized for which the thickness of the layer impacts the steered beam angle and thus the viewing angles. The number of viewing angles which can be embedded into the microstructures of the display pixels is dependent on the surface area available for each display pixel 140. The available surface area is a function of the height and shape of the display pixels 140, as delineated in FIG. 2. The thickness of the nanostructures included on each frame pixels 142 depends on the optical dispersion characteristics of the thin film layer 114 deposited on the nanostructures. The color filtering characteristics of the nanostructures are determined by reflection and absorption resonances in the structured thin film layer 114, and the aspect ratio of the nanostructures.

The color of the viewed image is determined by the reflection spectrum of the reflected incident light. The reflection, transmission, and absorption parameters of the reflection determine the spectrum of the light received by the user. Specifically, the combined reflected, transmitted, and absorbed light sums to unity. When absorption is negligible, e.g., in a lossless coating material, a dip in transmission translates to a peak in reflection, and vice versa. When absorption is considered, the absorption resonances will have a similar effect on the reflection spectrum. Usually, a dominant peak or dip in the reflection spectrum provides the hue, saturation, and luminescence of the reflected color. Therefore, the dimensions of the metasurface structures are tailored to obtain the needed reflection peaks and dips. The bandwidth of the resonances is also important in setting the reflected color, especially its hue (how pure the color is), and the bandwidth ties to the optical mode volume and absorption loss, which are a function of metasurface structures.

The thin film layer 114, a metallic or dielectric layer, covers the polymer layer 112 and can include all display pixels 140 and nanoimprinted metasurface nanostructures on each of the frame pixels 142. In some implementations, the layer 114 is a combination of a metallic layers, or a combination of dielectric layers.

The layer 114 and the nanostructures, either embossed into the polymer layer 112 or etched into the material layer 114, provide modal dispersion properties for the spectral filtering (e.g., color filtering) in a reflection mode. Modal dispersion is a distortion mechanism occurring in dispersive materials, such as dielectric materials, photonic crystals, plasmonic crystals, or single light scatterers, in which the signal is spread in time because the propagation velocity of the optical signal is not the same for all resonant modes. The absorption characteristics of the layer 114 when shaped onto the polymer nanostructures included on each of the frame pixels 142 tune one or more color parameters of reflected light, such as saturation, brightness, or hue.

If the layer 114 is metallic, plasmonic resonances forming in this layer 114 tailor the spectral characteristics of reflected light, facilitating color filtration. The plasmonic resonances are enabled by the negative refractive index of the metallic thin film layer 114 and can be localized or propagating surface plasmon resonances. In such implementations, subtractive color filtration is produced by the plasmonic resonance absorbing one part of the visible spectrum and reflecting the rest. The color filtering is driven by the absorption and is relatively broadband, e.g., typically >50 nm bandwidth. Implementations utilizing a metallic layer 114 include silver, aluminum, chromium, and/or other metals.

If the layer 114 is a dielectric material, the refractive index of the thin film layer 114 is sufficiently high to support optical modes when positioned on the low-refractive-index polymer layer 114 made of photosensitive polymeric resins (e.g. UV resin) or other dielectric materials. In addition to the high refractive index contrast, the dielectric film is thick enough to support Mie resonances and enable optical mode formation. Color filtering, e.g., absorption of a part of the visible spectrum, has reduced absorption bandwidth compared to plasmonic absorption, and a narrower bandwidth is achieved e.g., typically <50 nm bandwidth.

The layer 114 thickness of an HRI material is sufficient to form an optical mode and be confined in the HRI layer 114. This thickness is in a range from about 50 nm to about 500 nm depending on the refractive index of the HRI layer 114 (e.g., from about 75 nm to about 450 nm, from about 100 nm to about 440 nm, from about 125 nm to about 350 nm, from about 150 nm to about 300 nm, from about 100 nm to about 150 nm, or from about 250 nm to about 500 nm). Higher refractive indices create smaller spatial volumes in which resonant modes exist, facilitating lower HRI layer 114 thicknesses. Implementations utilizing an HRI layer 114 have a refractive index in a range from about 2.4 to about 4.5. Examples of materials which provide such a refractive index include silicon, titanium dioxide (TiO₂), germanium, niobium pentoxide (Nb₂O₅), or silicon nitride (Si₃N₄). The refractive index of the HRI material is within about 0.9 of the polymer layer 112 (e.g., within about 0.8, within about 0.7, within about 0.6, or within about 0.5).

The adhesive layer 130 adheres the flexible thin film stack 110 onto a flexible/hard substrate 160. The adhesive layer 130 has a similar refractive index to that of embossed resin thin film stack 110 (e.g., sufficient to reduce Fresnel reflections at the interface, e.g., the refractive index contrast is less than about 0.2). In some implementations, the adhesive layer comes with a primer layer and has a thickness in a range from about 3 μm to about 6 μm (e.g., from about 4 μm to about 5 μm, from about 4 μm to about 6 μm, from about 3 μm to about 4 μm). In implementations including a primer layer, the primer layer promotes adhesion between the adhesive layer and other surfaces contacted to the adhesive layer 130, such as the film stack 110. The adhesive layer 130 has a thickness in a range from about 5 μm to about 15 μm (e.g., from about 8 μm to about 12 μm, from about 10 μm to about 12 μm, from about 5 μm to about 12 μm, from about 5 μm to about 10 μm, from about 8 μm to about 10 μm, or from about 5 μm to about 8 μm). The thickness of the adhesive layer is at least partially determined (e.g., thicker or thinner) depending on the product utilized in the display 100. Examples include water-based pressure sensitive adhesives, latent reactive adhesive, and thermoplastic adhesive films.

The substrate 160 serves as the carrier of the thin film stack 110 and can be optically transparent or opaque depending on the application. In some implementations, the substrate 160 is a paper or polymer banknote having a thickness between about 75 μm and about 100 μm.

A plan view of the display device 100 and an exploded view of a microstructure forming a display pixel 140 is shown in FIG. 2. The film stack 110 is divided into equally-sized controllably-shaped display pixels 140, also termed image pixels, P. The surface of the display pixels 140 is portioned into an array of frame pixels 142. In some implementations, the frame pixels 142 are equally sized, e.g., of equal dimensions. The frame pixels 142 are formed onto the surface of the display pixel 140 and have a substantially planar surface. A ray normal to the planar surface of the frame pixels 142 determines the respective viewing angle for each frame pixel 145 with respect to a reference system, such as viewpoint of a viewer I₁ or I₂. Along the edge of the display pixel 140 of FIG. 2 are exemplary column and row numbers, 1-8. In FIG. 2, each frame pixel 142 is given a coordinate based on their column and row number and is denoted as Cij.

Each frame pixel 142 at a given coordinate i, j of the frame pixels 142 Cᵢⱼ within a display pixel 140 Pᵢ constitutes a single color pixel of an image, or frame of an animation, displayed at a corresponding distinguishable viewing angle. The image received by a viewer at a particular viewing angle is reconstructed from all identically angled frame pixels 142 embedded in the display pixels 140 of the film stack 110. For example, frame pixel C₁₁ provides the color for pixel P₁ of an image (e.g., image 1) to be viewed at angle 1, C₁₂ provides the color for pixel P₁ of a second image (e.g. image 2) to be viewed at angle 2, C₂₁ provides the color for pixel P₁ of third image (e.g. image 9) to be viewed at angle 9, etc. In this way, the frame pixels 142 at location C₁₁ of all display pixels 140 over the entire display device 100 provide one image (image 1), and the frame pixels 142 at location C₁₂ of all display pixels 140 provide a second image (image 2), different than the first image, and so forth.

The dimensions of the frame pixel 142 depend on the number of frames to display in a desired animation or image (e.g., a single frame), and the size of the display pixels 140. In general, the size of the display pixels 140 is below 64 microns (μm) to approximate the resolution detectable by the eye of the subject. In some implementations, the size of the display pixels 140 is 72 μm. In one example, the size of the display pixels 140 is 72 μm when an 18×18 array (324 frames) of 4-μm-wide frame pixels 142 are manufactured onto each display pixel 140. Alternatively, a 9×9 array (81 frames) of 8-μm-wide frame pixels 142. In some examples, the number of frames is up to 256 frames which creates conditions in which a 4 μm-wide frame pixel 142 is desirable. In alternative examples, the animation includes frame counts higher than 256 frames, for which sub-micron (e.g., <1 μm) frame pixel 142 size is beneficial. In one case, the frame pixels 142 correspond to a line of nanostructures (e.g., single period), i.e. dimensions of about 4 μm to about 120 nm. Said another way, the frame pixels 142 dimensions is in a range from about 120 nm×120 nm to about 72 μm×72 μm. Larger dimensions of the frame pixels 142 facilitate the display of single images, while smaller dimensions facilitate animations with higher frame counts. Larger dimensions for frame pixels 142 decrease the resolution, e.g., the amount of image information displayed in the physical area of the frame pixel 142, of displayed images or frames while smaller dimensions increase image/frame resolution. As examples, frame pixels 142 dimensions of about 72 μm×72 μm achieve 350 pixels per inch (ppi) resolution while dimensions of about 4 μm×120 nm achieve 2.1×10⁵ ppi resolution. As an alternative example, 6350 ppi resolution is achieved with 4 μm-wide frame pixels 142.

When the device 100 is displaying a single static image, the display pixel 140 size should be about 40 μm or smaller, e.g., about equal to the detectable resolution of the subject eye. When the device 100 is displaying an animation, e.g., a sequence of frames, the display pixel 140 can be as large as about 100 μm, and preferably smaller than about 72 μm. In this case, differences between the surface normals of neighboring frame pixels 142 and the angular overlap of their viewing directions adds a certain level of ‘blur’ to the display which prevents eye from detecting the individual frames of the animation, and provides a fluid transition between animation frames and a fluid animation. This is realized when the number of frames is large enough (e.g. >16) and the frame pixel 142 angles are not fully distinguishable by eye.

In some implementations, the display pixel 140 embeds a single frame pixel 142 (e.g., a static single image). In such examples, the frame pixel 142 size, and the display pixel 140 size, is as low as 1 μm. In implementations in which the display pixel 140 embeds multiple animation frames, e.g., multiple frame pixels 142, the minimum display pixel 140 size is equal to the number of embedded animation frames multiplied by the size of frame pixels 142. The range for the size of frame pixels 142 is given above.

The surface profile, shown in more detail with respect to FIG. 3 below, of the display pixel 140 ties directly to the viewing angles and the optical rendering of the displayed animation, and dependent on manufacturing techniques. In our process, the shape of the display pixel 140 in the flexible thin film stack 110 is defined by embossing a hard stamp (e.g., a shim) onto the photopolymer or thermoplastic resin shown in FIG. 1. The display pixel 140 in the stamp is manufactured by electron beam lithography techniques to provide adequate resolution for producing distinguishable facets, but other methods, such as direct laser writing, ion milling, and photolithography, may enable producing such display pixels 140 depending on the size of the frame pixels 142. The display pixels 140, patterned using electron beam lithography, undergo a dry etching process to be scaled to the targeted surface profile.

The number of frame pixels 142 embedded on a display pixel 140 surface can change in dimension based on the size of the frame pixels 142 and the number of images to be displayed at distinguishable viewing angles. In the non-limiting example shown in FIG. 3, a cross-sectional view of a display pixel 140 is shown. The cross-sectional shape of the display pixel 140 is dome shaped (e.g., substantially hemispheric). In some implementations, the display pixel 140 is smoothly curved. Alternatively, the display pixel 140 surface is faceted with individual planar sections corresponding to the frame pixels 142. The devices 100 as described in FIGS. 1-3 can be faceted, in some implementations, and each facet is as planar as nanofabrication limitations allow.

The surface of the display pixel 140 is divided into several frame pixels 142 with 14 frame pixels 142 shown in the figure. Rays B1 through B14 originate from a common light source and are shown contacting each frame pixel 142. Reflected rays B′1 through B′14 are shown which represent the reflected rays from respective frame pixels 142. The reflected rays indicate the viewing angles for each frame pixel 142, which are calculated using the Fresnel Equations assuming that the metasurface nanostructures do not steer (e.g., substantially change the reflected angle of the incident rays) the incoming beam, e.g., the incident rays of light B1 through B14. The normal ray of each frame pixel 142 average surface is pictured as lines crossing the display pixel 140 surface. In the case that the metasurface nanostructures steer the beam and, the normal angle of the facets may be calculated to target an intended viewing angle in combination with the nanostructures, see “Light: Science & Applications,” volume 7, page 17178 (2018), Nano Lett. 2012, 12, 12, 6223-6229.

The size of a display pixels 140 image pixel may be in a range from about 1 micron to about 96 microns (e.g., from about 5 microns to about 90 microns, from about 10 microns to about 96 microns, from about 5 microns to about 80 microns, from about 15 microns to about 70 microns, from about 25 microns to about 50 microns). In some implementations, the size of a frame pixel 142 may be between about 1 micron to about 72 microns The size of the display pixels 140 and frame pixels 142 can depend on the number of images or frames to be displayed per display pixels 140 pixel of the film stack 110. The area of each frame pixels 142, e.g., facet of display pixels 140 surface, in some implementations, theoretically substantially matches the piecewise linear approximation of the plane normal to the targeted viewing angle. In practice, the combination of, for example, lithography and thermal post-processing prevents realizing a substantially planar surface for one or more frame pixels 142. In such cases, an average normal vector can be assigned to the frame pixels 142 and the viewing angle may be calculated accordingly. In this case, a level of crosstalk from one frame pixel 142 to other frame pixels 142 may be expected.

To color the frame pixels 142, each is covered with at least a plurality of metasurface nanostructures 144 that reflect the intended color and reconstruct the desired image. The frame pixel 142 may include a single plurality of metasurface nanostructures 144 which reflect the desired color, or it may include multiple weighted regions of such nanostructures 144, which reflect the intended color when combined. For example, in the embodiment shown in FIG. 2, each frame pixels 142 of the display pixel 140 is populated by only a single type of metasurface nanostructures 144. As the number of manufacturable metasurface nanostructures 144 is limited, the number of color bases used for constructing the intended color via combining weighted nanostructures 144 is limited. Practically, the nanoimprinting resolution limits the number of metasurface-based color pixels (e.g., frame pixels 142) manufacturable with distinguishable colors. Color pixels may be distinguishable and may serve as the basis of a color space, e.g., distinguishable pitch, diameter and depth of the nanostructures.

The individual nanostructures 144 made by nanoimprinting/embossing methods are typically between about 50 nm and about 300 nm in width/diameter and the features of the array of nanostructures 144 has a pitch (e.g., a separation between individual nanostructures 144) in a range from about 100 nm to about 350 nm. The depth of nanostructures 144 is in a range from about 50 to about 300 nanometers.

If the material layer 114 is a metal and the nanostructures 144 induce plasmonic resonances to control the reflected incident light properties, the thickness of the material layer 114 is in a range from about 25 nm to about 100 nm. If the material layer 114 is a high refractive index dielectric material, the thickness of the material layer 114 is in a range from about 50 nm to about 500 nm.

Similar to the display pixels 140, nanostructures 144 are transferred onto the polymer layer 112 using embossing methods, such as NIL or EBL. In some implementations, the display pixels 140 and the nanostructures 144 are embossed on the polymer layer 112 during the same operation, using the same stamp. In such methods, the nanostructures 144 can be functionalized by depositing the film layer 114 of metal or high refractive index dielectric (or a combination of both). The periodicity, width, and height of the embossed nanostructures 144 are adjusted to fine-tune their modal dispersion characteristics and therefore their reflection and absorption properties.

In alternative production methods, the hard stamp above only provides display pixels 140 which are embossed onto the polymer layer 112. In such methods, the film layer 114 of metal or high refractive index dielectric (or a combination of both) is deposited on the embossed and cured display pixels 140, followed by a second lithography method that manufactures, e.g., defines the positions and dimensions of, the nanostructures 144. By employing a subsequent etching process, the nanostructures 144 in the thin film layer 114 are defined and overlaid on the frame pixels 142 of the display pixels 140. In this case, the second lithography process defines the etching mask.

Due to design and manufacturing imperfections of the display pixels 140, frame pixels 142, and nanostructures 144 differences between the angular distribution of the light reflected off each frame pixel 142 produced by film stack 110, and the ideal angular distribution that was designed to be reflected off each frame pixel 142 may exist. When the display device 100 is viewed under a light source with a broad angular distribution (e.g., such as a natural light source, such as the sun), light may be reflected from multiple facets of a display pixel to the viewer at once, potentially causing a blurred image to be observed on the device 100.

Each viewing direction indicated by B′1-B′14 has a broad angular distribution under a broadly distributed light source. The overlap of these distributions can cause the projected images to blur. Moving the centers of the angular distributions for each frame pixel 142 apart can reduce overlap which can reduce associated blur. The centers of these angular distributions can be changed by modifying the normal angle of each of the frame pixels 142 within the display pixel 140 surface. For example, with a dome-like display pixel 140, shown in FIG. 3, increasing the height, h, and maintaining the width of the base, e.g., the width of each of the corresponding display pixels 140, increases the angular separation of the surface normal angle in each respective frame pixel 142, which increases the angular separation of centers of the viewing distributions for each frame pixel 142.

In some cases (e.g., in which there is no overlap between the angular distributions of each viewing direction), transitions between frames of the image as the viewer observes the device 100 from different angles can be overly sharp, akin to video stutter. Some amount of overlap between the angular distributions can provide smoothening of transitions between images. In some cases, the normal angles for each frame pixel 142 are oriented so that the angles between them adjacent frame pixels 142 is sufficient to reduce blur for most common light sources and reducing the appearance of ‘stutter’. As one example, if the angular spread of the light off of each frame pixel 142 is sufficiently broad that the viewer always sees >2 frame pixels at a time, the image can be blurred. If the angular spread is sufficiently small that the viewer can only ever see 1 frame pixel at a time, the transition can be extremely sharp. Therefore, implementations in which the viewer sees between 1 and 2 frame pixels 142 at a time reduce the appearance of stutter. Preferably the viewer sees 1 frame pixel 142 when that frame pixel 142 is viewed at the nominal viewing angle (e.g., the normal angle of the facet) and an even combination of two frame pixels 142 when viewed from directly between the nominal two viewing angles.

Said another way, a frame pixel 142 not along the edges of the display pixel 140 is surrounded by 8 neighboring frame pixels 142. The viewer receives reflected light proportional to 1/x from four closest neighbors and reflected light proportional to 1/y from the diagonal neighbors. Preferably, x and y should preferably be larger than about 1 and smaller than about 10 (e.g., smaller than about 8, smaller than about 6, or smaller than about 5) to smoothen the transition.

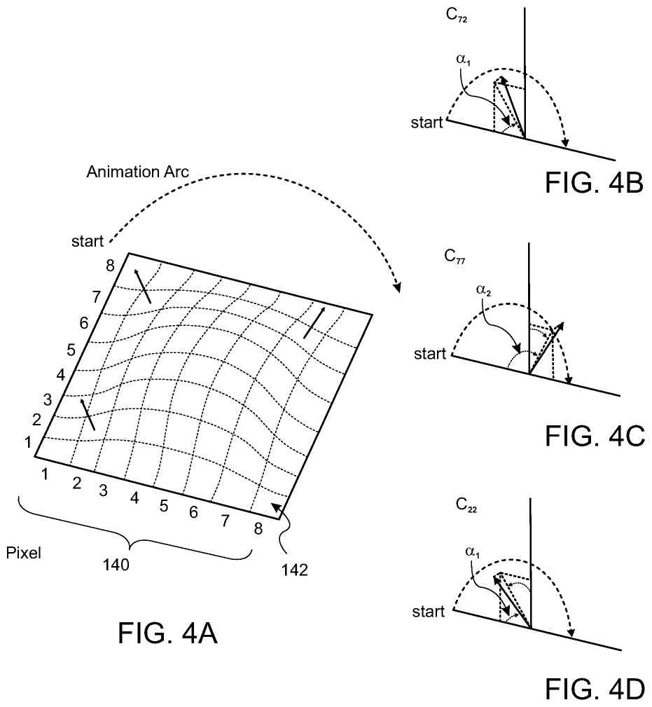

Each frame pixel 142 projects a singular image of a sequence forming the animation. A sequence of projections corresponding to each frame pixel 142 along an animation arc make the animation appear on the surface of the sample when viewed. Parallax effects arise by rendering each viewing angle through a scene individually. Additional renderings produce an animated scene. An arc along which an animation is intended to be viewed is termed an animation arc. The display pixel 140 and an example labeled animation arc along which the animation is intended to be viewed is shown in FIG. 4A. The animation arc defines the arc through which temporal information is projected, e.g., the time in which the animation plays. A point in the arc from which a user views the reflected light from the device 100 corresponds to a time in the animation and determines how far through the animation the image seen is.

For example, the example animation arc of FIG. 4A indicates an animation direction with the use of a dashed arrow arc. As the viewer perceives the light reflected from the individual frame pixels 142 along the animation arc in the direction indicated by the arrow, e.g., beginning at ‘start’ and progressing away, the animation appears to play ‘forward’ in time. As the viewer perceives the light from the frame pixels 142 in the reverse direction of the indicated arrow, e.g., progressing toward ‘start’ along the animation arc, the animation appears in reverse order, e.g., plays ‘backwards’ in time.

Each frame pixel 142, Cᵢⱼ, is associated with a particular ‘time’ in the animation by projecting the viewing direction of the frame pixels 142 onto the plane of the animation arc. For example, referring now to FIGS. 4A and 4B, when the viewing direction of frame pixel C₇₂ (indicated by a projected arrow from the surface of frame pixels 142 C₇₂) is projected into the plane of the animation arc the resulting vector forms an angle α₁ with the start of the animation arc. However, referring now to FIGS. 4A and 4C, the viewing direction of C₇₇ when projected similarly, forms angle α₂ with the start of the animation arc, and therefore shows a frame that takes place later in the animation.

In some examples, multiple frame pixels 142 project a common time in the animation, e.g., they project onto the same time location along the animation arc. Referring to FIGS. 4A, 4C, and 4D, frame pixels 142 C₇₂ and C₂₂ where, due to the symmetry of the display pixel 140 around the animation arc, the projection of the viewing direction of each of the respective frame pixels 142 onto the animation arc is identical even though the viewing directions are different. Once the angle along the animation arc is determined for a given frame pixel 142, the scene to be rendered for that frame pixel 142 is determined by interpolating the input frames of the intended animation.

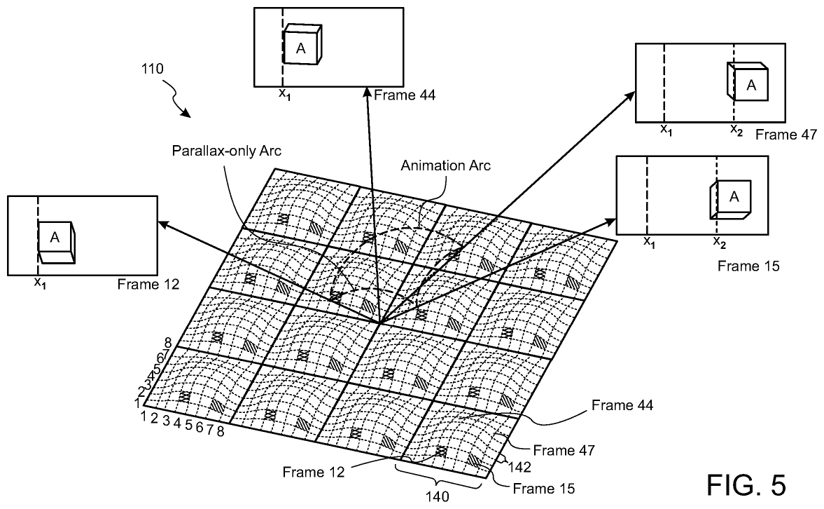

The film stack 110 surface, highlighting four sets of frame pixels 142 and the images shown by each of those sets of frame pixels 142, is shown in FIG. 5. In some implementations, frame pixels 142 are paired to show distinct behaviors depending upon their interaction with the animation arc. The indicated display pixels 140 includes four highlighted sets of frame pixels 142, indicated as frame 12 at frame pixel C_{2,4}, frame 15 at frame pixel C_{2,7}, frame 44 at frame pixel C_{6,4}, and frame 47 at frame pixel C_{6,7}. Corresponding frame pixels 142 are highlighted in each of the display pixels 140 show in the film stack 110 of FIG. 5.

A simulated projection of the perceived image (cube A) corresponding to frames 12, 44, 47, and 15 are shown clockwise above the image of film stack 110. When rotating the sample perpendicular to the animation arc, for example from viewing the image shown by frame pixels C_{2,4} to frame pixels C_{6,4} (frame 12 to frame 44), or from frame pixels C_{2,7} to frame pixels C_{6,7} (frame 15 to frame 47), the difference between the frames corresponds only to changes due to parallax and not due to changes in animation time. The parallax-related changes are demonstrated in frames 12 versus 44, and frames 15 versus 47 where the cube rotates in perceived space and maintains the position along the indicated x-dimension, x₁ or x₂. However, when rotating the sample along the animation arc, for example from viewing the image shown by frame pixels C_{2,4} to frame pixels C_{2,7} (frame 12 versus frame 15), or from frame pixels 6,4 to frame pixels 6,7 (frame 44 versus frame 47), the image of the cube changes and moves in space, from x₁ to x₂.

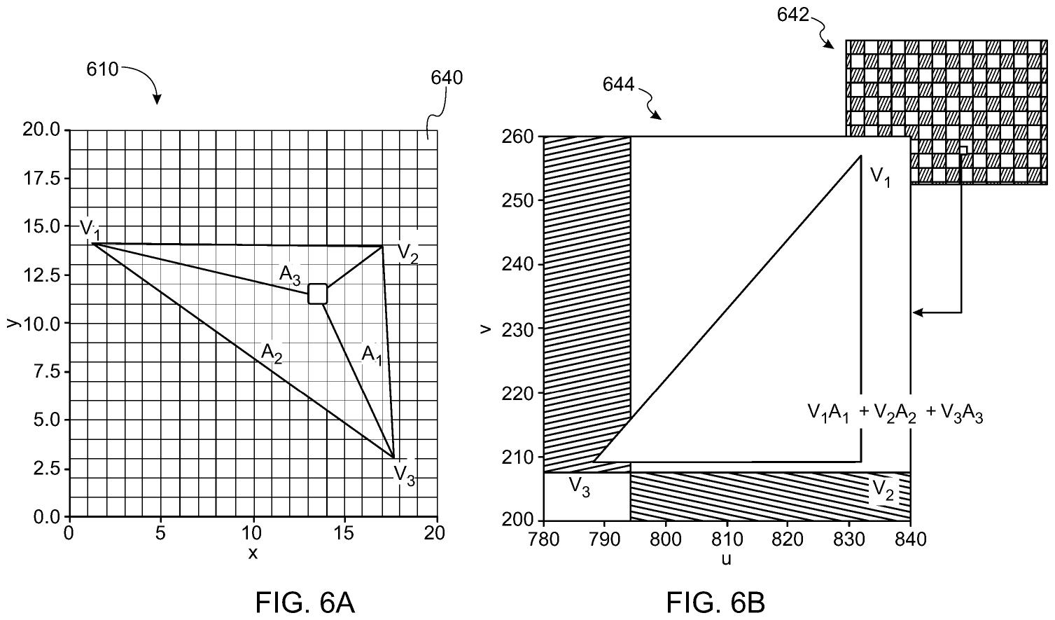

An example illustrating determining the color of a frame pixel based on a simulated scene to capture depth perception from parallax can be explained with respect to the projection of a polygon of a scene to be rendered. A projection of a polygon (the triangle defined by points V1, V2, and V3) from the scene onto a simulated device film stack 610, for set of frame pixels' viewing angle, is shown in FIG. 6A. The square at the center highlights a pixel to be colored. The x- and y-axes are shown in arbitrary dimension units. Squares, or pixels, on the xy plane (e.g., simulated device film stack 610 surface) each represent a display pixel 640 of the film stack 610. Each display pixel 640 within the projection has its frame pixel associated with this viewing angle colored by this polygon from the scene.

A1, A2, and A3 are the areas of three sub-triangles defined by two vertices of the polygon (e.g., V1 and V2, V2 and V3, or V1 and V3) and the center of the square. When 3D objects are stored, such as the polygon, and a texture map is used to determine color data of the polygon at individual frame pixels, the color data stored in the object is the location in the texture map onto which each vertex of a polygon maps. In order to determine the color of intermediate points on the polygon, the texture map is interpolated between the vertices.

In some implementations, the polygon includes colors determined by a texture map 642. The texture map 642 and a zoomed-in view of the texture map 644 with the locations onto which the polygon and frame pixel of interest map is shown in FIG. 6B. Individual frame pixels onto which the polygon was mapped determine the color of the polygon at the respective locations. The weight of each vertex of the polygon at the location of the frame pixel (highlighted square, left) is calculated where the weights associated with V1, V2, V3, are the areas A1, A2, A3, of each sub triangle. In the scene, each vertex (V1, V2, V3) of the triangle will have associated u, v coordinates of the texture map. Exemplary coordinate axes u and v are shown having arbitrary dimension units along the x- and y-axes of weighting chart 644. The texture map position at which each frame pixel obtains its color value is determined by multiplying vertices' respective u, v coordinates by the vertices' respective weights for that frame pixel (e.g., according to the equation inset to the weighting chart 644). The color for each frame pixel is pulled from the texture map at the location determined for the frame pixel based on the u,v coordinates and weights.

Replacing the pixel location within the projected polygon with a ray intersection location on a polygon surface, the same process is used to calculate the color of an object for raytracing.

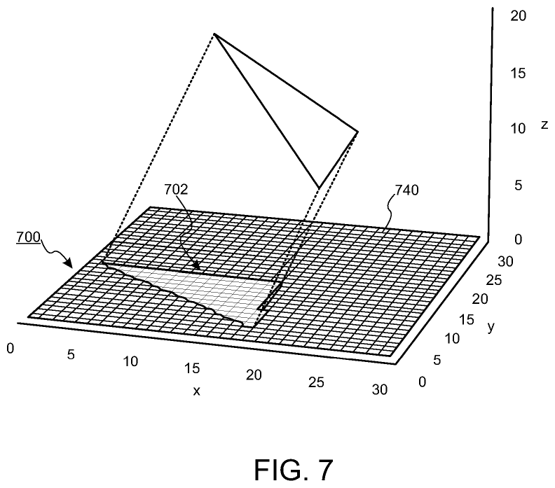

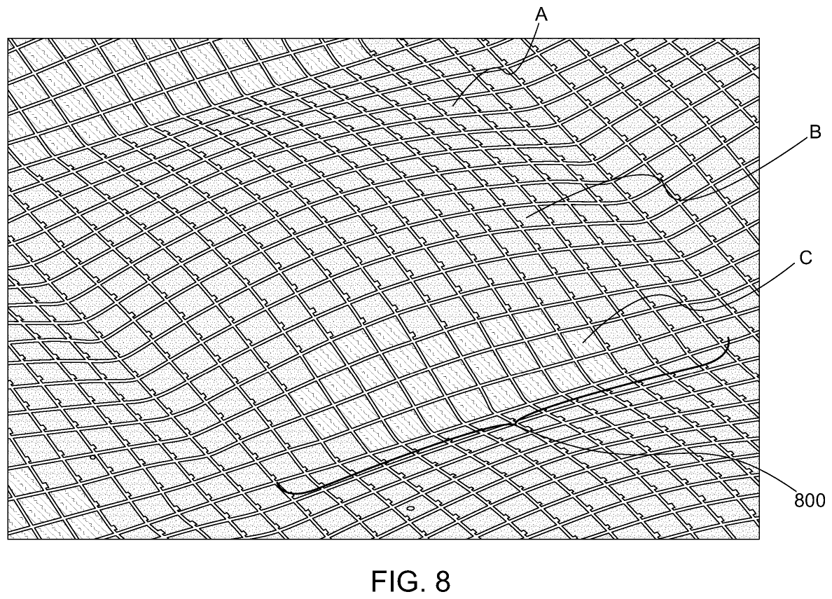

A projection 702 of a polygon (triangle) from a simulated scene onto a surface of a device 700, for the viewing angle of a set of highlighted frame pixels, is shown in FIG. 7. Squares, or pixels, on the xy plane each represent a display pixel 740 on the surface of the device 700. Each display pixel 740 within the projection 702 (shown as dark grey) has its frame pixel associated with this viewing angle colored by the polygon from the scene.

To determine the color of this frame pixel on every display pixel, this process is repeated for every polygon in the scene. If multiple polygons map onto this frame pixel on a single display pixel, the color of the polygon that is closest to the viewer, that is the one that would occlude the others, is used to color the frame pixel.

To know the color of every frame pixel on the samples' display pixels, this process is repeated for the viewing angle associated with every set of frame pixels.

Fabrication of a specific display device typically starts with making a mold with surface containing the display pixel, frame pixel, and metasurface patterns. In certain examples, the mold is made using lithographic techniques. Exemplary steps include a polished wafer (e.g., but not limited to, a silicon wafer). The wafer is cleaned from dust and contaminates like organic materials or others that may exist on the surface. The cleaned wafer is coated with a layer of electron beam resist. The coated wafer is then exposed to the patterns of the micro-structures using an electron-beam lithography machine. Baking and development yields patterns of micro-structures in the resist coating the wafer. This “soft” pattern is transferred to the “hard” wafer by using a dry etching machine, for example. Chemical cleaning and baking remove the extra resist and leaves a clean silicon wafer with patterns of the designed micro-structured surface on it. This wafer is then recoated with another layer of electron resist, thinner than the prior resist layer. The recoated wafer is then exposed to the patterns of plasmonic structures using the electron beam lithography machine. Further steps of development, baking, dry etching, and cleaning results in formation and transfer of plasmonic structures to the micro-surface.

The resulting mold formed using lithographic techniques can be used as a mold master from which additional molds are formed. For example, the mold structure can be replicated using electroplating to form intermediate molds and production molds. This process also allows scaling up the size of a production mold by tiling together intermediate molds and electroplating the tiled structure. Intermediate molds and production molds can be formed using metals, such as nickel.

The mold can be used in the fabrication of a display as follows. Here, the designed micro- and nanostructures after fabrication on a mold is cast on a different substrate, such as a plastic sheet, using an ultra-violet curable resin. A layer of a metal or dielectric is then deposited on the patterned surface of the cast copy. For example, in cases where a metal is deposited, the metal can be sputtered onto the surface. In cases where the layer is dielectric, the dielectric can be deposited using thermal evaporation. In either case, the material being deposited should conform to the patterned surface. The resulting coated casting is laminated (e.g., using an adhesive) to a substrate with additional protective layers. For example, a protective layer can be deposited on the cast layer on the surface opposite the structured surface. Such casting or embossing, coating, lamination, or other operations are typically available in industrial format which may be employed for large-scale production of the devices.

Reference will now be made to specific examples illustrating the disclosure. It is to be understood that the examples are provided to illustrate exemplary embodiments and that no limitation to the scope of the disclosure is intended thereby.

### EXAMPLES

### Example 1: Shim

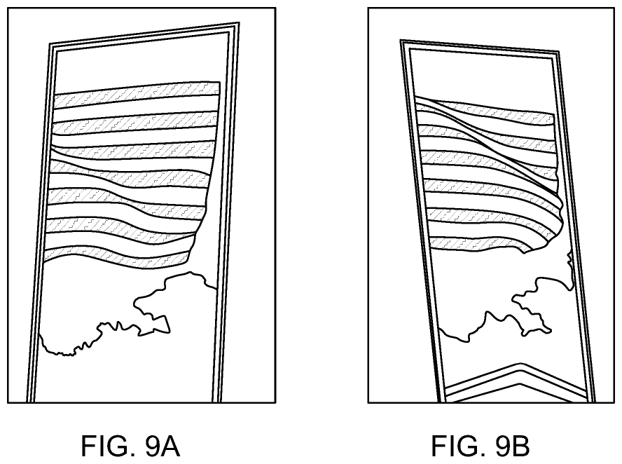

An SEM image of a nickel (Ni) shim 810 for manufacturing a display device is shown in FIG. 9. Shim 810 is made using a fabrication method similar to the method described in WO2022130346A1, entitled “Optical Diffractive Display,” filed Dec. 17, 2021, the entire contents of which is incorporated herein by reference. WO2022130346A1 describes patterning diffractive nanostructures on microstructures using gray-scale e-beam lithography. Shim 810 is similarly formed, using instead binary e-beam lithography. Shim 810 contains 256 total frame pixels, some of which include nanostructures and others that are free from nanostructures. Three individual frame pixels, A, B, and C including respective nanostructures are identified on one display pixel 840 of the sample 810. In this example, some of the frame pixels (e.g., A and B) that include nanostructures reflect a brownish red color. Other frame pixels (e.g., C), which do not have nanostructures, reflect white. Each of the frame pixels has a different orientation, i.e., different azimuthal and polar viewing angles. The frame pixels are arranged on a micro-dome and are symmetrically rotated around the dome. The underlying microstructure follows a mathematical function (a dome which is stretched at the corners to match the square base of the pixel). The surface normal to each of the frame pixels cover an azimuthal angular range from −180° to +180°. The dome has a square footprint with of 64 μm×64 μm and a vertical range of 8.4 μm. Each square frame pixel has is 4 μm×4 μm (when projected on the flat surface).

Shim 810 can be used to make a mold, from which a polymer layer can be embossed directly, or shim 810 can be directly applied on a curable mold to emboss the patterns.

### Example 2: Plasmonic Metasurface Sample Showing Animated Flag

A sample display made using shim 810 with a plasmonic metasurface showed an animation of a flag moving in the wind when viewed across an animation arc by a user. Two frames of the animation on the plasmonic sample 900 as viewed from two different angles are shown in FIG. 10A and FIG. 10B, respectively. The camera is at +40° and −40° rotation with respect to the vertical axis in the plane of the figure. The sample is rotated about 45° with respect to the horizontal axis in the plane of the figure, with the camera directly facing the plane of the figure (i.e., along the axis normal to the plane of the figure). A light source illuminated the sample from behind the camera. A crease in the flag is shown in different positions on the flag in the frames, depicting movement of the flag in the wind.

### EQUIVALENTS

Those skilled in the art will recognize, or be able to ascertain, using no more than routine experimentation, numerous equivalents to the specific embodiments described specifically herein. Such equivalents are intended to be encompassed in the scope of the following claims. A number of embodiments have been disclosed. Other embodiments are in the following claims.

1. A display comprising a two-dimensional array of display pixels, the display comprising:
a substrate extending in a plane;
a polymer layer supported by the substrate, the polymer layer having a surface patterned to correspond to the two-dimensional array of display pixels, a shape of the surface within each display pixel varying with respect to the plane so that different areas of each display pixel reflect light incident on the display from a common direction into different viewing angles, each of the different areas corresponding to a respective frame pixel, the surface at each of the different areas comprising a respective metasurface pattern; and
a layer of a first material on the surface of the polymer layer, the first material being different from a material composing the polymer layer, the metasurface patterns and the layer of the first material being configured so that the reflected light is spectrally filtered by each frame pixel, the metasurface patterns for different frame pixels of at least some of the display pixels varying so that each of the at least some of the display pixels reflect differently colored light into the different viewing angles.

2. The display of claim 1, wherein the metasurface patterns for the frame pixels of each display pixel vary so that the display reflects incident light to present different images into at least some of the different viewing angles.

3. The display of claim 2, wherein the metasurface patterns for the frame pixels of each display pixel vary so that the different images correspond to different spatial views of an object.

4. The display of claim 2, wherein the metasurface patterns for the frame pixels of each display pixel vary so that the different images correspond to different frames in an animation of an object.

5. The display of claim 2, wherein the metasurface patterns of each display pixel vary in a first manner for the frame pixels so that the different images correspond to different frames in an animation of an object for different viewing directions in a first plane, and the metasurface patterns of each display pixel vary in a second manner for the frame pixels so that the different images correspond to different spatial views of the object for different viewing directions.

6. The display of claim 1, wherein the surface of the polymer layer of each display pixel is dome-shaped.

7. The display of claim 1, wherein the first material comprises a metal.

8. The display of claim 1, wherein the first material has a refractive index higher than a refractive index of the polymer layer.

9. The display of claim 1, wherein each display pixel comprises an array of the frame pixels, each frame pixel in the array corresponding to a respective one of the different viewing angles.

10. The display of claim 1, wherein the metasurface patterns and layer of the first material are arranged so that each frame pixel spectrally filters incident light by plasmonic resonance.

11. The display of claim 1, further comprising an adhesive layer between the substrate and the polymer layer.

12. The display of claim 1, further comprising a protective layer, the polymer layer being arranged between the substrate and the protective layer.

13. The display of claim 1, wherein the layer of the first material substantially conforms to the metasurface pattern of each of the different areas.

14. A method of manufacturing a display comprising a two-dimensional array of display pixels, the method comprising:
patterning a surface of a polymer layer to correspond to the two-dimensional array of display pixels, a shape of the surface within each display pixel varying with respect to a plane so that different areas of each display pixel reflect light incident on the display from a common direction into different viewing angles, each of the different areas corresponding to a respective frame pixel, the surface at each of the different areas comprising a respective metasurface pattern; and
depositing a layer of a first material on the polymer layer, the first material being different from a material composing the polymer layer, the metasurface patterns and the layer of the first material being configured so that the reflected light is spectrally filtered by each frame pixel, the metasurface patterns for different frame pixels of at least some of the display pixels varying so that each of the at least some of the display pixels reflect differently colored light into the different viewing angles.

15. The method of claim 14, wherein the polymer layer is patterned by embossing a surface of the polymer layer with a mold.

16. The method of claim 14, further comprising laminating the polymer layer to a substrate.

17. The method of claim 14, further comprising disposing a protective layer on a surface of the polymer layer opposite the patterned surface.

18. The method of claim 14, wherein the first material comprises a metal and the material is deposited using sputtering methods.

19. The method of claim 14, wherein the first material comprises a dielectric material and the material is deposited using thermal evaporation methods.

20. The method of claim 14, wherein depositing the first material comprises depositing the layer of the first material to at least partially conform to the two-dimensional array of display pixels and to the corresponding frame pixels.

21. The method of claim 14, wherein the layer of the first material conforms to the metasurface pattern of each of the different areas.

22. An optically variable device, comprising:
an array of microstructures, each microstructure comprising a plurality of metasurface patterns, the metasurface patterns constructed to reflect and spectrally filter incident light to present different images of an object into different viewing angles, the different images comprising a sequence of frames of an animation of the object and comprising different spatial views of the object for a given frame in the sequence.

23. The device of claim 22, wherein the different viewing angles correspond to a dimension of the array of microstructures.

24. The device of claim 22, wherein when reflected incident light is viewed across a first range of viewing angles, different frames of the animation are presented to a viewer and when incident light is viewed across a second range of viewing angles, different from the first range of viewing angles, different spatial views of the frames of the animation are presented to the viewer.

25. The device of claim 22, wherein the metasurface patterns are configured to reflect and spectrally filter incident light to present respective frames of the sequence of frames for different viewing angles lying in a first plane relative to the array of microstructures and to present different respective spatial views of the object for different viewing angles outside the first plane.

26. The device of claim 25, wherein the metasurface patterns are configured to reflect and spectrally filter incident light to present different respective spatial views of the object for a given frame of the sequence of frames for different viewing angles lying in a second plane relative to the array of microstructures, the second plane being perpendicular the first plane.
